(19) United States
(12) Patent Application Publication
(10) Pub. No.: US 2026/0244158 A1
(43) Pub. Date: Aug. 20, 2026

(54) Crown Assembly and Wearable Device

(71) Applicant: HUAWEI TECHNOLOGIES CO., LTD., Shenzhen (CN)

(72) Inventors: Shuai Yuan, Xi'an (CN); Bingyang Sun, Xi'an (CN); Yu Guo, Xi'an (CN); Chao Xue, Xi'an (CN); Shifeng Fu, Xi'an (CN)

(73) Assignee: HUAWEI TECHNOLOGIES CO., LTD., Shenzhen (CN)

(21) Appl. No.: 19/647,462

(22) Filed: Apr. 14, 2026

Related U.S. Application Data
(63) Continuation of application No. PCT/CN2025/075823, filed on Feb. 5, 2025.

(30) Foreign Application Priority Data
Apr. 19, 2024 (CN) 202410473998.0

(51) Int. Cl. G04B 3/04

(52) U.S. Cl. CPC G04B 3/041

(57) ABSTRACT

A crown assembly includes a crown cap and a crown stem. The crown cap includes a first top plate and a first side plate that together form a crown cap groove. The crown stem includes a stem body and a stem connection portion including a second top plate and a second side plate that together form a crown stem groove. A plastic connector is disposed between the crown cap and the crown stem and includes a third top plate and third side plate that together form a connector groove. A portion of the crown stem is inside the crown cap groove. The connector groove is in the crown cap groove and the crown stem groove is in the connector groove. The crown cap groove, the connector groove, and the crown stem groove each open in an axial direction substantially perpendicular to an outer surface of the first top plate.

### CROSS-REFERENCE TO RELATED APPLICATIONS

This is a continuation of International Patent Application No. PCT/CN2025/075823, filed on February 5, 2025, which claims priority to Chinese Patent Application No. 202410473998.0, filed on April 19, 2024. The disclosures of the aforementioned applications are hereby incorporated by reference in their entireties.

### TECHNICAL FIELD

This disclosure relates to the field of electronic devices, and more specifically, to a crown assembly and a wearable device.

### BACKGROUND

With development of wearable devices, wearable devices such as a smart watch are increasingly widely used, and a rotatable crown of the smart watch is also more widely used. However, there are still some problems in actual application of the rotatable crown at present, such as insufficient mechanical reliability of the rotatable crown and low aesthetics of the rotatable crown. Therefore, there is an urgent need to provide a rotatable crown assembly and a wearable device that have better effect.

### SUMMARY

This disclosure provides a crown assembly and a wearable device. The crown assembly may be used in the wearable device, and aesthetics of the crown assembly can be improved while meeting mechanical reliability of the crown assembly.

According to a first aspect, a crown assembly is provided, where the crown assembly includes a crown cap and a crown stem, the crown cap includes a first top plate and a first side plate, the first side plate and the first top plate are enclosed to form a crown cap groove, and the crown stem includes a stem body and a stem connection portion. The stem body includes a first end and a second end, the stem connection portion includes a second top plate and a second side plate, the first end of the stem body is connected to the second top plate, the second side plate and the second top plate are enclosed to form a crown stem groove, a part of the crown stem is located inside the crown cap groove, and directions of the crown stem groove and the crown cap groove are the same.

For example, the first top plate includes an outer surface and an inner surface. The outer surface of the first top plate is an outward-facing surface, namely, a surface facing a user, and is a surface that the user can directly touch. The inner surface of the first top plate is an inward-facing surface, namely, a surface away from the user. Similarly, the first side plate also includes two surfaces, namely, an outer surface of the first side plate and an inner surface of the first side plate. The outer surface of the first side plate is a surface facing the user, and the inner surface of the first side plate is a surface away from the user.

For example, the second top plate includes an outer surface and an inner surface. The outer surface of the second top plate is an outward-facing surface, namely, a surface facing the crown cap. The inner surface of the second top plate is an inward-facing surface, namely, a surface away from the crown cap. Similarly, the second side plate also includes two surfaces, namely, an outer surface of the second side plate and an inner surface of the second side plate. The outer surface of the second side plate is a surface close to the crown cap, and the inner surface of the second side plate is a surface away from the crown cap.

For example, the stem connection portion of the crown stem is at least partially located inside the crown cap groove. It should be understood that the outer surface of the second top plate is in contact with the inner surface of the first top plate, the outer surface of the second side plate is in contact with the inner surface of the first side plate, and the stem connection portion may be embedded in the crown cap groove.

It should be understood that orientations of the crown stem groove and the crown cap groove are the same. For example, the crown stem groove and the crown cap groove both are disposed toward a watch movement.

In this embodiment, the crown cap and the crown stem in the crown assembly are separately and independently disposed, so that the crown cap and the crown stem may be made of different materials. For example, the crown cap may be made of a material that can be anodized or a material that is easy to color, and the crown stem may be made of a material with selected mechanical strength. In this way, the crown assembly can present any color, and mechanical reliability of the crown assembly is ensured, thereby balancing aesthetics and mechanical performance. In addition, the structure of the crown assembly provided in this embodiment is simple, manufacturing costs are low, and structural space occupied by the crown assembly is small.

In a possible implementation, the crown cap is made of any one of the following materials: aluminum, magnesium, titanium, zinc, and nickel; and the crown stem is made of stainless steel or titanium alloy.

For example, the crown cap may be made of an aluminum alloy material, a magnesium alloy material, a titanium alloy material, a zinc alloy material, a nickel alloy material, or the like, and the crown stem may be made of a stainless steel material, a titanium alloy material (for example, TC4), or the like.

In this embodiment, the crown cap may be made of a material (for example, aluminum, magnesium, titanium, zinc, or nickel) that can be anodized on a surface, so that the crown cap can be colored through surface anodization. It should be understood that surface anodizing is a process of forming an oxide layer on a metal surface, to improve corrosion resistance, hardness, and appearance of the metal. The crown stem may be made of a stainless steel material or a titanium alloy material. Compared with an aluminum alloy material, strength of the crown stem can be increased, so that mechanical reliability of the crown assembly can be ensured.

In a possible implementation, a first connection portion is disposed on an inner surface of the first side plate of the crown cap, a second connection portion is disposed on an outer surface of the second side plate of the stem connection portion, and the first connection portion is fastened to the second connection portion.

In this embodiment, by disposing the first connection portion on the crown cap and disposing the second connection portion on the crown stem, the first connection portion and the second connection portion may be used together to implement fastening between the first connection portion and the second connection portion, thereby implementing fastening between the crown cap and the crown stem.

In a possible implementation, the first connection portion is a rotation groove, the second connection portion is a boss that fits the rotation groove, and the boss is capable of rotating into the rotation groove.

It should be noted that positions of the rotation groove and the boss may be exchanged. For example, the first connection portion may be the boss, and the second connection portion may be the rotation groove.

In this implementation, the first connection portion can be fastened to the second connection portion by cooperatively using the boss and the rotation groove, that is, by combining the first connection portion and the second connection portion in a mechanical rotation manner, so that the crown cap can be fastened to the crown stem.

In a possible implementation, a first groove is further disposed on the inner surface of the first side plate of the crown cap, a second groove is further disposed on an outer surface of the second side plate of the stem connection portion, and a projection of the second groove on the first side plate at least partially overlaps the first groove, or a projection of the first groove on the second side plate at least partially overlaps the second groove.

It should be understood that there may be a plurality of first grooves and a plurality of second grooves. The plurality of first grooves may be disposed along the inner surface of the first side plate, and the plurality of second grooves may be disposed along the outer surface of the second side plate.

In this embodiment, the first groove and the second groove are disposed, and a projection of the second groove on the first side plate at least partially overlaps the first groove, so that when the crown cap is assembled with the crown stem, a combination gap exists between the crown cap and the crown stem. After the crown stem is assembled with the crown cap through rotation, adhesive dispensing may be performed on the combination gap, so that the first side plate of the crown cap and the second side plate of the stem connection portion can be bonded together, thereby avoiding relative rotation between the crown cap and the crown stem and ensuring reliability of the crown assembly.

In a possible implementation, the first connection portion is a first threaded structure disposed in a circumferential direction, the second connection portion is a second threaded structure disposed in a circumferential direction, and the crown cap rotates through the first threaded structure into the second threaded structure, so that the crown cap is fastened to the crown stem.

It should be noted that the positions of the first thread structure and the second thread structure may be exchanged. For example, the first connection portion may be the second thread structure, and the second connection portion may be the first thread structure.

In this implementation, the first thread structure may be rotated and embedded into the second thread structure, to implement fastening between the crown cap and the crown stem. In addition, after the crown cap is assembled with the crown stem, no assembly gap exists between the crown cap and the crown stem, providing a more attractive appearance.

In a possible implementation, a first extension segment disposed in an axial direction is disposed on the inner surface of the first side plate, and a second extension segment disposed in an axial direction is disposed on the outer surface of the second side plate.

It should be understood that there may be a plurality of first extension segments and a plurality of second extension segments, and the first extension segment and the second extension segment may be configured to store a hot melt adhesive. By disposing the first extension segment and the second extension segment, after the hot melt adhesive is dispensed on the inner surface of the first top plate of the crown cap, when the crown cap is assembled with the crown stem, the adhesive may overflow from the inner surface of the first top plate to the first extension segment and the second extension segment. In this way, the first side plate of the crown cap may be closely bonded to the second side plate of the stem connection portion, to prevent the crown cap from rotating relative to the crown stem, and ensure reliability of the crown assembly.

In a possible implementation, the crown assembly further includes a plastic connector, the plastic connector is located between the crown cap and the crown stem, and the plastic connector is connected to the stem connection portion of the crown stem.

For example, the plastic connector may be made of polyphenylene sulfide and 20% glass fiber.

It should be noted that the plastic connector mainly plays a role of connecting the crown cap and the crown stem, that is, the plastic connector mainly plays a connection role, and the plastic connector is mainly made of a plastic material. Another type of material may be used. In this application, the plastic connector is mainly described as an example of a plastic material. However, in some other embodiments, the plastic connector may not be made of a plastic material.

In this implementation, the plastic connector may be connected between the crown cap and the stem connection portion of the crown stem. The crown cap may be fastened to the crown stem through the plastic connector.

In a possible implementation, the plastic connector includes a third top plate and a third side plate. The third top plate and the third side plate are enclosed to form a connector groove. The connector groove is located in the crown cap groove, and the crown stem groove is located in the connector groove.

For example, the third top plate includes an outer surface and an inner surface. The outer surface of the third top plate is an outward-facing surface, namely, a surface close to the crown cap. The inner surface of the third top plate is an inward-facing surface, namely, a surface close to the crown stem. Similarly, the third side plate also includes two surfaces: an outer surface of the third side plate and an inner surface of the third side plate, where the outer surface of the third side plate is a surface close to the crown cap, and the inner surface of the third side plate is a surface close to the crown stem.

It should be understood that, the inner surface of the third top plate is in contact with the outer surface of the second top plate, the inner surface of the third side plate is in contact with the outer surface of the second side plate, and the stem connection portion may be embedded into the connector groove; and the outer surface of the third top plate is in contact with the inner surface of the first top plate, the outer surface of the third side plate is in contact with the inner surface of the first side plate, and the plastic connector may be embedded into the crown cap groove.

It should be understood that orientations of the crown stem groove, the crown cap groove, and the connector groove are the same. For example, the crown stem groove, the crown cap groove, and the connector groove are all disposed toward a watch movement.

In a possible implementation, the plastic connector is fastened to the crown cap by using a nano molding process or an insert molding process, and the plastic connector is fastened to the stem connection portion of the crown stem by using an adhesive dispensing process.

In this implementation, when the crown assembly is assembled, the plastic connector and the crown cap may be first assembled together by using a nano molding process or an insert molding process, and then the plastic connector and the stem connection portion of the crown stem are assembled together by using an adhesive dispensing process, to finally implement fastening between the crown cap and the crown stem.

In a possible implementation, the stem connection portion of the crown stem is fastened to the plastic connector by using a nano molding process or an insert molding process, and the crown stem is fastened to the crown cap by using an adhesive dispensing process.

In this implementation, when the crown assembly is assembled, the plastic connector and the stem connection portion of the crown stem may be assembled together first by using a nano molding process or an insert molding process, and then the plastic connector and the crown cap are assembled together by using an adhesive dispensing process, to finally implement fastening between the crown cap and the crown stem.

In a possible implementation, a third connection portion is disposed on an inner surface of the third side plate of the plastic connector, a fourth connection portion is disposed on an outer surface of the second side plate of the stem connection portion, and the third connection portion is fastened to the fourth connection portion.

In this implementation, by disposing the third connection portion on the plastic connector and disposing the fourth connection portion on the crown stem, the third connection portion and the fourth connection portion may be used together to implement fastening between the third connection portion and the fourth connection portion, thereby implementing fastening between the plastic connector and the crown stem, and finally implementing fastening between the crown cap and the crown stem.

In a possible implementation, the third connection portion is a guide base, the fourth connection portion is a guide groove, and the guide base is clamped with the guide groove.

In this implementation, the guide base and the guide groove may be used in cooperation, that is, the guide base is clamped into the guide groove, to implement fastening between the plastic connector and the crown stem, and prevent relative movement between the plastic connector and the crown stem.

In a possible implementation, a fifth connection portion is disposed on an inner surface of the first side plate of the crown cap, a sixth connection portion is disposed on an outer surface of the third side plate of the plastic connector, and the fifth connection portion is fastened to the sixth connection portion.

In this implementation, by disposing the fifth connection portion on the crown cap and disposing the sixth connection portion on the plastic connector, the fifth connection portion and the sixth connection portion may be used together to implement fastening between the fifth connection portion and the sixth connection portion, thereby implementing fastening between the crown cap and the plastic connector, and finally implementing fastening between the crown cap and the crown stem.

In a possible implementation, the stem connection portion of the crown stem is fastened inside the crown cap in an interference fit manner.

In this implementation, the stem connection portion of the crown stem may be fastened inside the crown cap groove in an interference fit manner, to implement fastening between the crown cap and the crown stem.

In a possible implementation, a protrusion is disposed on the inner surface of the first side plate of the crown cap, a recess is disposed on the outer surface of a second side plate of the stem connection portion, and the protrusion is clamped in the recess.

In this implementation, the protrusion is disposed on the crown cap, and the recess corresponding to the protrusion is disposed on the stem connection portion of the crown stem. The crown cap is fastened to the crown stem through clamping between the protrusion and the recess, to prevent relative rotation between the crown cap and the crown stem when the crown cap is rotated.

According to a second aspect, a wearable device is provided. The wearable device includes the crown assembly according to any one of the possible implementations of the first aspect.

In a possible implementation, the wearable device may be a watch, a band, or the like.

It should be noted that, for beneficial effects of the second aspect, refer to beneficial effects of the first aspect. Details are not described herein again.

### BRIEF DESCRIPTION OF DRAWINGS

FIGS. 1A and 1B illustrate a structure of a smart watch according to an embodiment;

FIGS. 2A, 2B and FIGS. 3A-3C are example diagrams of structures of a crown according to an embodiment;

FIG. 4 to FIG. 6C are other example diagrams of structures of a crown according to an embodiment;

FIGS. 7A, 7B and FIGS. 8A-8C are other example diagrams of structures of a crown according to an embodiment;

FIGS. 9A, 9B and FIGS. 10A-10C are other example diagrams of structures of a crown according to an embodiment;

FIGS. 11A, 11B and FIGS. 12A-12C are other example diagrams of structures of a crown according to an embodiment;

FIGS. 13A, 13B and FIGS. 14A and 14B are other example diagrams of structures of a crown according to an embodiment; and

FIGS. 15A, 15B and FIGS. 16A-16C are other example diagrams of structures of a crown according to an embodiment.

### DESCRIPTION OF EMBODIMENTS

The following describes embodiments in detail. Examples of embodiments are shown in the accompanying drawings. In the accompanying drawings, same or similar reference numerals indicate same or similar elements or elements having same or similar functions. The following embodiments described with reference to the accompanying drawings are examples, and are merely intended to explain this application, but should not be construed as a limitation on this application.

Unless otherwise defined, a technical term or a scientific term used herein shall have a general meaning understood by a person of ordinary skill in the technical field of this disclosure. In the description, it should be understood that a direction or a location relationship indicated by the terms "up", "down", "front", "back", "left", "right", "vertical", "horizontal", "top", "bottom", "inside", or "outside" is based on a direction or a location relationship shown in accompanying drawings, is merely for ease of description and simplification, and is not intended to indicate or imply that referred apparatus or element needs to have a specific direction, or be constructed or operated in a specific direction. Therefore, this is not understood as a limitation.

Reference to "one embodiment", "some embodiments", or the like described in this specification means that a feature, structure, or characteristic described with reference to the embodiment is included in one or more embodiments. Therefore, statements such as "in an embodiment", "in some embodiments", "in some other embodiments", and "in other embodiments" that appear at different places in this specification do not necessarily mean referring to a same embodiment. Instead, the statements mean "one or more but not all of embodiments", unless otherwise specifically emphasized in another manner. The terms "include", "have", and their variants all mean "include but are not limited to", unless otherwise specifically emphasized in another manner.

Currently, a crown of a wearable device (for example, a smart watch) is mostly made of stainless steel. When the crown is surface-treated and colored, a surface treatment process of the stainless steel crown is mostly physical vapor deposition (PVD). However, there are limited colors of PVD surface treatment, and there may be a problem that color matching is inconsistent and not visually appealing. However, if another material (for example, an aluminum alloy material) is used, and anodizing processing is performed on the aluminum alloy material, although varied appearance effects are met, a problem that a rotation function of the crown fails due to deformation of the aluminum alloy in a mechanical test exists.

Therefore, to implement mechanical reliability and varied appearance effects, a new type of crown assembly and wearable device need to be provided.

It should be noted that the wearable device provided in embodiments may include wrist wearable devices such as a smart band and a smart watch, and may even include a smart wearable device in another part like an ankle or a neck. It should be understood that the "smart watch" in embodiments is not limited to a "watch", and may be another electronic device, for example, another smart wearable device. In some cases, the smart watch may alternatively be a mechanical watch or a pocket watch. This is not limited in this application.

It should be understood that this application is described by using an example in which the wearable device is a smart watch 100.

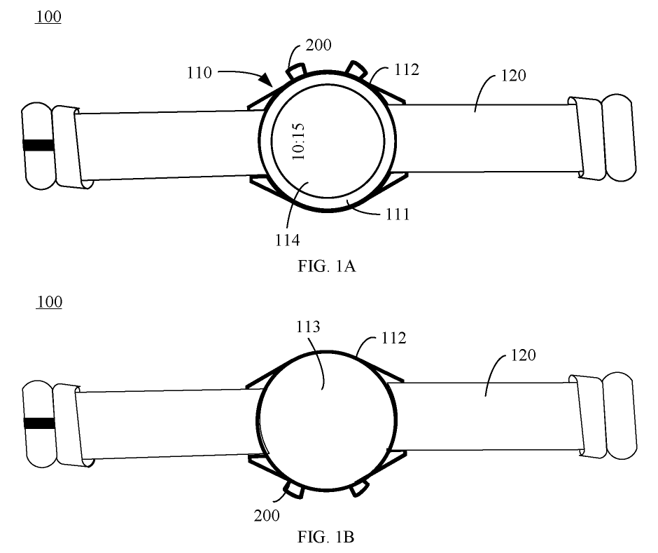

FIGS. 1A and 1B diagram a structure of the smart watch 100 according to an embodiment. FIG. 1A is a front view of the smart watch 100, and FIG. 1B is a rear view of the smart watch 100.

As shown in FIGS. 1A and 1B, the smart watch 100 provided in this embodiment includes a watch body 110 and a watch band 120. The watch body 110 may also be referred to as a watch head, and is a main part of the watch. The watch band 120 usually includes two parts, which are respectively connected to two opposite sides of the watch body 110. The two parts are used in cooperation, to wear the smart watch 100 on a wrist of a user.

It can be understood that an inner surface of the watch body 110 is a surface that is of the watch body 110 and that is in contact with the wrist (or another part) of the user, and an outer surface of the watch body 110 is a surface that is of the watch body 110 and that is away from the wrist (or another part) of the user.

As shown in FIGS. 1A and 1B, in some embodiments, the watch body 110 may include a front cover 111, a watch frame 112, a rear cover 113, and a display 114. The watch frame 112 is in a hollow ring structure, and may be configured to connect the front cover 111 and the rear cover 113. The front cover 111 and the display 114 are fastened to one end of the watch frame 112, and the rear cover 113 is fastened to the other end of the watch frame 112. The front cover 111, the display 114, the watch frame 112, and the rear cover 113 jointly define an inner cavity of the smart watch 100. The inner cavity is configured to accommodate electronic components such as a speaker, a main board, a camera, a microphone, a sensor, a memory, a processor, and a battery.

The watch frame 112 provides mechanical support and protection for the entire smart watch 100. The watch frame 112 is made of a material with sufficient hardness. The material of the watch frame 112 may be, for example, stainless steel, ceramic, titanium alloy, aluminum alloy, copper alloy, or hard plastic. As shown in FIGS. 1A and 1B, in this embodiment, a cross-sectional shape of the watch frame 112 is a circle. In another implementation, the cross-sectional shape of the watch frame 112 may alternatively be a rectangle, a square, an ellipse, or the like. This is not limited in this application.

The front cover 111 covers one end of the watch frame 112, and the rear cover 113 covers the other end of the watch frame 112. When worn, the rear cover 113 is in contact with the wrist of the user. The front cover 111 and the watch frame 112 are sealed, and the rear cover 113 and the watch frame 112 are sealed, to achieve waterproof effect.

Optionally, the front cover 111 and the rear cover 113 may be made of materials such as stainless steel, titanium alloy, glass, ceramic, aluminum alloy, copper alloy, or plastic.

Optionally, the front cover 111 and the rear cover 113 may be covered on the watch frame 112 in a screw manner, a clamping manner, or the like. A sealing ring may be disposed between the front cover 111 and the watch frame 112, and between the rear cover 113 and the watch frame 112, to improve sealing and waterproof effect at a joint between the front cover 111 and the watch frame 112 and a joint between the rear cover 113 and the watch frame 112. The sealing ring may be made of a high-elasticity material like silicone or rubber.

Optionally, the front cover 111 and the watch frame 112, or the rear cover 113 and the watch frame 112, or the front cover 111, the watch frame 112, and the rear cover 113 may be manufactured into an integrated structure by using an integrated molding process, thereby simplifying a structure of the watch and improving production efficiency. In addition, because there may be no bonding gap between the front cover 111 and the watch frame 112 and between the rear cover 113 and the watch frame 112, overall waterproof effect of the watch can be improved.

For example, the integrated molding process may be casting, sintering, injection molding, 3D printing, or the like, but is not limited thereto.

The display 114 is configured to provide human-machine interaction between a user and a smart watch, for example, display information (for example, information such as time, news, and weather) to the user or receive information entered by the user (for example, receive a control instruction of the user).

Optionally, the display 114 may be a touchscreen, for example, may be a liquid-crystal display (LCD), an organic light-emitting diode (OLED), an active matrix organic light-emitting diode (AMOLED), a flexible light-emitting diode (FLED), a mini-LED, a micro-LED, a micro-OLED, or a quantum dot light-emitting diode (QLED) display, but is not limited thereto.

The display 114 is mounted on the front cover 111, and an accommodation cavity formed between the front cover 111, the rear cover 113, the watch frame 112, and the display 114 can accommodate a watch movement. The watch movement is a main body part of the smart watch, and the watch movement may be formed by integrating a plurality of electronic components. A composition of the watch movement is not limited in this embodiment. For example, the watch movement may be formed by any one or a combination of a plurality of components inside the smart watch.

It should be noted that, in some embodiments, in consideration of aesthetics of the smart watch 100, the front cover 111 may not be disposed on the watch body 110. That is, the watch body 110 includes the watch frame 112, the rear cover 113, and the display 114. The watch frame 112 is in a hollow ring structure, and may be configured to connect the display 114 and the rear cover 113. The display 114 is fastened to one end of the watch frame 112, and a rear cover 113 is fastened to the other end of the watch frame 112. The display 114, the watch frame 112, and the rear cover 113 jointly define an inner cavity of the smart watch 100. The inner cavity is configured to accommodate electronic components such as a speaker, a main board, a camera, a microphone, a sensor, a memory, a processor, and a battery.

In some embodiments, the watch body 110 may include a front panel and a rear panel. The front panel may include the front cover 111 and one part of the watch frame 112, and the rear panel may include the rear cover 113 and the other part of the watch frame 112. In an example, the front panel and the rear panel may be manufactured into an integrated structure by using an integrated molding process. In another example, the front panel and the rear panel may be independently manufactured, and the front panel and the rear panel may be covered together to form the watch body 110 in a manner like bonding, screwing, or clamping. For example, a sealing ring may be disposed between the front panel and the rear panel, to implement sealing effect.

As shown in FIGS. 1A and 1B, the smart watch 100 provided in this embodiment further includes a crown 200 (namely, a crown component) disposed on an outer wall of the watch frame 112. The crown 200 may also be referred to as a key or a button. The crown 200 is connected to an internal watch movement (not shown in the figure), and can be used to adjust a function of the smart watch 100, for example, adjust time, power on or off, adjust a play volume of a speaker, and adjust a display brightness. The crown 200 can be rotated or pressed, to implement the foregoing functions.

It should be understood that a through hole (not shown in the figure) is disposed on the watch frame 112. One part (for example, a crown stem) of the crown 200 may pass through the through hole from the outside of the smart watch 100 and be inserted into the inside of the watch body 110, to connect to the watch movement inside the watch body 110. The other part (for example, a crown cap) of the crown 200 may be exposed and located outside the watch body 110.

Embodiments mainly relate to improvement of the structure of the crown 200, and provide a new crown design solution. The structure of the crown is simple, and the crown is easy to disassemble, and the smart watch can be easily repaired. In addition, a same smart watch can be used with crowns of different colors, to improve aesthetics.

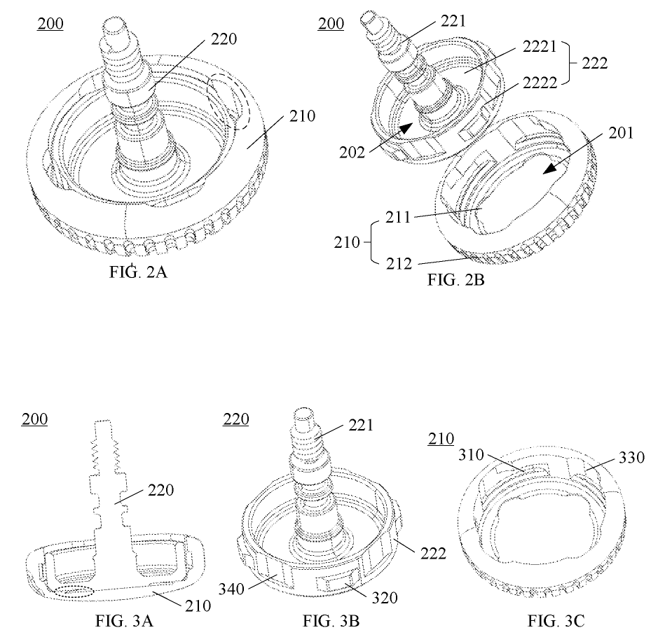

FIGS. 2A, 2B and FIG. 3A, 3B and 3C are example diagrams of structures of a crown according to an embodiment. FIG. 2A is a diagram of an overall structure of a crown, and FIG. 2B is an exploded view of the crown. FIG. 3A is a cross-sectional diagram of the crown. FIG. 3B is a diagram of a structure of a crown stem, and FIG. 3C is a diagram of a structure of a crown cap.

As shown in FIGS. 2A and 2B, a crown 200 (or referred to as a crown assembly) includes a crown cap 210 and a crown stem 220. The crown cap 210 includes a first top plate 211 and a first side plate 212. The first side plate 212 and the first top plate 211 are enclosed to form a crown cap groove 201.

For example, the crown cap groove 201 may be formed by the first side plate 212 surrounding the first top plate 211. The first side plate 212 may be annular or circular, or may be in another shape, for example, square or rhombic. This is not limited.

For example, the first top plate 211 includes an outer surface and an inner surface. The outer surface of the first top plate 211 is an outward-facing surface, namely, a surface facing the user, and is a surface that the user can directly touch. The inner surface of the first top plate 211 is an inward-facing surface, namely, a surface away from the user. Similarly, the first side plate 212 also includes two surfaces, namely, an outer surface of the first side plate 212 and an inner surface of the first side plate 212. The outer surface of the first side plate 212 is a surface facing the user, and the inner surface of the first side plate 212 is a surface away from the user.

That the first side plate 212 and the first top plate 211 are enclosed to form the crown cap groove 201 may be understood as that the inner surface of the first side plate 212 and the inner surface of the first top plate 211 may be enclosed to form the crown cap groove 201. The crown cap groove 201 can accommodate a part of a structure of the crown stem 220.

As shown in FIG. 2B, the crown stem 220 includes a stem body 221 and a stem connection portion 222. The stem body 221 includes a first end and a second end. The first end of the stem body 221 is an end close to the crown cap 210, and the first end of the stem body 221 may be connected to the stem connection portion 222. The second end of the stem body 221 is an end away from the crown cap 210, and the second end of the stem body 221 may be connected to the watch movement.

For example, the stem body 221 and the stem connection portion 222 may be manufactured into an integrated structure by using an integrated molding process. For example, the integrated molding process may be casting, sintering, injection molding, 3D printing, or the like, but is not limited thereto.

As shown in FIG. 2B, the stem connection portion 222 includes a second top plate 2221 and a second side plate 2222, the first end of the stem body 221 is connected to the second top plate 2221, and the second side plate 2222 and the second top plate 2221 are enclosed to form a crown stem groove 202. A part of the crown stem 220 is located inside the crown cap groove 201, and directions (or orientations) of the crown stem groove 202 and the crown cap groove 201 are the same.

For example, the crown stem groove 202 may be formed by the second side plate 2222 surrounding the second top plate 2221. The second side plate 2222 may be annular or circular, or may be in another shape, for example, square or rhombic. This is not limited.

For example, the second top plate 2221 includes an outer surface and an inner surface. The outer surface of the second top plate 2221 is an outward-facing surface, namely, a surface facing the crown cap 210. The inner surface of the second top plate 2221 is an inward-facing surface, namely, a surface away from the crown cap 210. Similarly, the second side plate 2222 also includes two surfaces, namely, an outer surface of the second side plate 2222 and an inner surface of the second side plate 2222. The outer surface of the second side plate 2222 is a surface close to the crown cap 210, and the inner surface of the second side plate 2222 is a surface away from the crown cap 210.

That the second top plate 2221 and the second side plate 2222 are enclosed to form the crown stem groove 202 may be understood as that the inner surface of the second top plate 2221 and the inner surface of the second side plate 2222 may be enclosed to form the crown stem groove 202. The crown stem groove 202 may accommodate a part of the stem body 221.

For example, a part or all of the stem connection portion 222 of the crown stem 220 may be located inside the crown cap groove 201. In other words, the outer surface of the second top plate 2221 is in contact with the inner surface of the first top plate 211, the outer surface of the second side plate 2222 is in contact with the inner surface of the first side plate 212, and the stem connection portion 222 may be embedded in the crown cap groove 201.

It should be understood that orientations of the crown stem groove 202 and the crown cap groove 201 are the same. For example, the crown stem groove 202 and the crown cap groove 201 both are disposed toward the watch movement.

In some embodiments, the crown cap 210 includes but is not limited to the following materials: aluminum, magnesium, titanium, zinc, and nickel. The crown stem 220 includes but is not limited to the following materials: stainless steel and titanium alloy. For example, the crown cap 210 may be made of an aluminum alloy material, a magnesium alloy material, a titanium alloy material, a zinc alloy material, a nickel alloy material, or the like, and the crown stem 220 may be made of a stainless steel material, a titanium alloy material, or the like.

The crown cap 210 may be made of a material (for example, aluminum, magnesium, titanium, zinc, or nickel) that can be anodized on a surface, so that the crown cap 210 can be colored through surface anodization. It should be understood that surface anodizing is a process of forming an oxide layer on a metal surface, to improve corrosion resistance, hardness, and appearance of the metal. The crown stem 220 may be made of a stainless steel material or a titanium alloy material (for example, TC4). Compared with an aluminum alloy material, strength of the crown stem 220 can be increased, so that mechanical reliability of the crown 200 can be ensured.

For example, in this embodiment, the crown cap 210 may be made of aluminum alloy, and the crown stem 220 may be made of stainless steel. In this way, aesthetics of the crown can be improved while mechanical strength of the crown stem is ensured.

In this embodiment, the crown cap 210 and the crown stem 220 in the crown 200 are separately and independently disposed, so that the crown cap 210 and the crown stem 220 may be made of different materials. For example, the crown cap 210 may be made of a material that can be anodized or a material that is easy to color, and the crown stem 220 may be made of a material with selected mechanical strength. In this way, the crown 200 can present any color, and mechanical reliability of the crown 200 is ensured, thereby balancing aesthetics and mechanical performance. In addition, the structure of the crown 200 provided in this embodiment is simple, manufacturing costs are low, and the crown 200 requires small structural space.

It should be noted that, in this embodiment, the crown 200 may be split into an independent crown cap 210 and an independent crown stem 220. The crown cap 210 and the crown stem 220 may be connected through interference riveting, in a thread manner, an insert molding manner, a nano molding manner, a mechanical knob manner, and an interference mechanical manner, and by using an adhesive dispensing process, and the like, to ensure stability between the crown cap 210 and the crown stem 220, thereby ensuring reliability of the crown 200.

It should be understood that, in embodiments provided in this application, insulation PVD processing may be performed at a contact position between the crown stem 220 and the crown cap 210, to prevent electrochemical corrosion between the crown cap 210 and the crown stem 220 during long-term wearing.

This embodiment mainly relates to how to implement fastening between the crown cap 210 and the crown stem 220. It should be understood that, in an embodiment, a connection mechanism may be disposed on the inner surface of the first side plate 212 of the crown cap 210 and the outer surface of the second side plate 2222 of the stem connection portion 222, to implement the fastening between the crown cap 210 and the crown stem 220. In some other embodiments, a connection mechanism may be disposed on the inner surface of the first top plate 211 of the crown cap 210 and the outer surface of the second top plate 2221 of the stem connection portion 222, to implement fastening between the crown cap 210 and the crown stem 220. In still some other embodiments, corresponding connection mechanisms may be disposed on the inner surface of the first top plate 211 of the crown cap 210, the inner surface of the first side plate 212, the outer surface of the second top plate 2221 of the stem connection portion 222, and the outer surface of the second side plate 2222 of the stem connection portion 222, to implement fastening between the crown cap 210 and the crown stem 220.

In some embodiments, a first connection portion is disposed on an inner surface of the first side plate 212 of the crown cap 210, a second connection portion is disposed on an outer surface of the second side plate 2222 of the stem connection portion 222, and the first connection portion is fastened to the second connection portion. It should be understood that, by disposing the first connection portion on the crown cap 210 and disposing the second connection portion on the crown stem 220, the first connection portion and the second connection portion may be used together to implement fastening between the first connection portion and the second connection portion, thereby implementing fastening between the crown cap 210 and the crown stem 220.

In an example, as shown in FIG. 3C, the first connection portion may be a rotation groove 310, the second connection portion may be a boss 320 that fits the rotation groove 310, and the boss 320 is capable of rotating into the rotation groove 310.

It should be noted that positions of the rotation groove 310 and the boss 320 may be exchanged. For example, the first connection portion may be the boss 320, and the second connection portion may be the rotation groove 310.

It should be understood that, in this implementation, the first connection portion can be fastened to the second connection portion by cooperatively using the boss 320 and the rotation groove 310, that is, by combining the first connection portion and the second connection portion in a mechanical rotation manner, so that the crown cap 210 can be fastened to the crown stem 220.

For example, as shown in FIG. 2B and FIG. 3C, a first groove 330 is further disposed on the inner surface of the first side plate 212 of the crown cap 210, a second groove 340 is further disposed on an outer surface of the second side plate 2222 of the stem connection portion 222, and a projection of the second groove 340 on the first side plate 212 at least partially overlaps the first groove 330, or a projection of the first groove 330 on the second side plate 2222 at least partially overlaps the second groove 340. It should be understood that there may be a plurality of first grooves 330 and a plurality of second grooves 340. The plurality of first grooves 330 may be disposed along the inner surface of the first side plate 212, and the plurality of second grooves 340 may be disposed along the outer surface of the second side plate 2222. FIGS. 2B, FIG. 3B and 3C show that there are four first grooves 330 and four second grooves 340.

The first groove 330 and the second groove 340 are disposed, and a projection of the second groove 340 on the first side plate 212 at least partially overlaps the first groove 330, so that when the crown cap 210 is assembled with the crown stem 220, a combination gap (as shown by a dashed line in FIG. 2A) exists between the crown cap 210 and the crown stem 220. After the crown stem 220 is assembled with the crown cap 210 through rotation, adhesive dispensing may be performed on the combination gap, so that the first side plate 212 of the crown cap 210 and the second side plate 2222 of the stem connection portion 222 can be bonded together, thereby avoiding relative rotation between the crown cap 210 and the crown stem 220 and ensuring reliability of the crown 200.

In some embodiments, the inner surface of the first top plate 211 of the crown cap 210 may undergo adhesive dispensing processing, and/or the outer surface of the second top plate 2221 of the stem connection portion 222 may undergo adhesive dispensing processing (an adhesive dispensing position may be a position shown by a dashed line in FIG. 3A). This can increase bonding stability between the crown cap 210 and the crown stem 220, and can ensure reliability of the crown 200.

In some embodiments, the inner surface of the first top plate 211 of the crown cap 210 may undergo laser engraving processing (namely, laser carving) and then undergo adhesive dispensing, and/or the outer surface of the second top plate 2221 of the stem connection portion 222 may undergo laser engraving processing (namely, laser carving) and then undergo adhesive dispensing. The laser engraving processing is performed to enhance a texture of the inner surface of the first top plate 211 of the crown cap 210 and/or a texture of the outer surface of the second top plate 2221 of the stem connection portion 222, so as to further increase bonding stability between the crown cap 210 and the crown stem 220, and further ensure reliability of the crown 200.

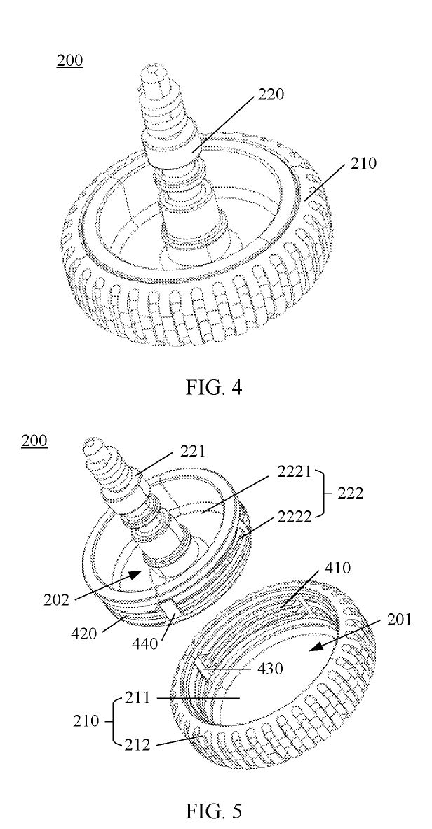

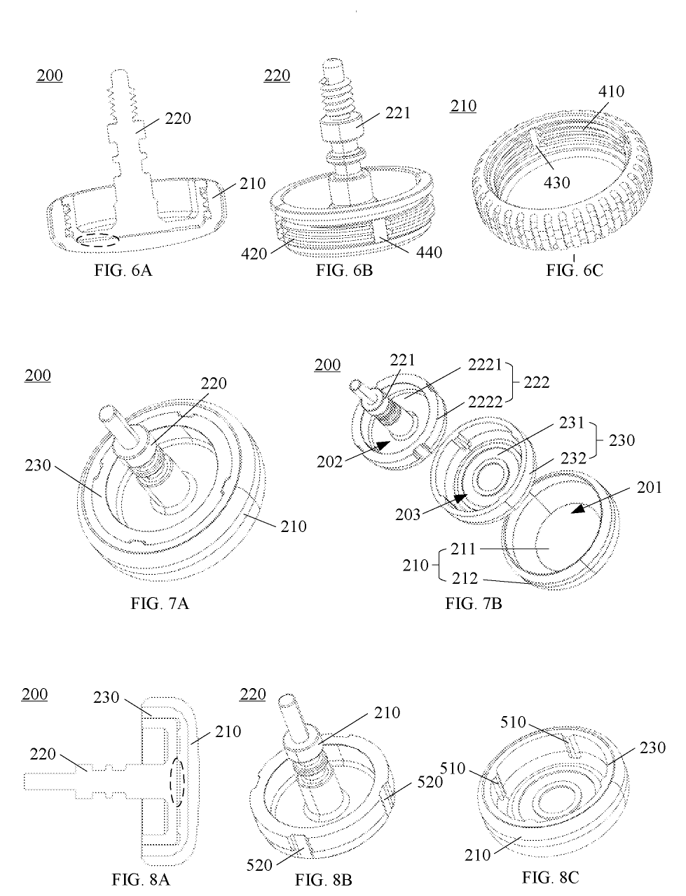

FIG. 4 to FIG. 6C are other example diagrams of structures of a crown according to an embodiment. FIG. 4 is a diagram of an overall structure of a crown, FIG. 5 is an exploded view of the crown shown in FIG. 4. FIG. 6A is a cross-sectional diagram of the crown. FIG. 6B is a diagram of a structure of a crown stem, and FIG. 6C is a diagram of a structure of a crown cap.

In the crown 200 shown in FIG. 4 to FIG. 6C, the first connection portion disposed on the inner surface of the first side plate 212 of the crown cap 210 may be a first thread structure 410 disposed in a circumferential direction, and the second connection portion disposed on the outer surface of the second side plate 2222 of the stem connection portion 222 may be a second thread structure 420 disposed in a circumferential direction.

It should be noted that the positions of the first thread structure 410 and the second thread structure 420 may be exchanged. For example, the first connection portion may be the second thread structure 420, and the second connection portion may be the first thread structure 410.

It should be understood that, in this implementation, the first thread structure 410 may be rotated and embedded into the second thread structure 420 (as shown by a dashed line in FIG. 6A), to implement fastening between the crown cap 210 and the crown stem 220. In addition, after the crown cap 210 and the crown stem 220 are assembled, no assembly gap exists between the crown cap 210 and the crown stem 220 (as shown in FIG. 4), providing a more attractive appearance.

For example, as shown in FIG. 5 and FIG. 6C, a first extension segment 430 disposed in an axial direction is disposed on the inner surface of the first side plate 212, and a second extension segment 440 disposed in an axial direction is disposed on the outer surface of the second side plate 2222. The axial direction may be understood as a length direction of the crown stem 220 or a direction of a rotation axis of the crown 200.

It should be understood that there may be one or more first extension segments 430 and second extension segments 440, and the first extension segment 430 and the second extension segment 440 may be configured to store hot melt adhesive. By disposing the first extension segment 430 and the second extension segment 440, after the hot melt adhesive is dispensed on the inner surface of the first top plate 211 of the crown cap 210 (for an adhesive dispensing position, refer to a position shown by a dashed line in FIG. 6A), when the crown cap 210 and the crown stem 220 are assembled, the adhesive may overflow from the inner surface of the first top plate 211 to the first extension segment 430 and the second extension segment 440. In this way, the first side plate 212 of the crown cap 210 may be closely bonded to the second side plate 2222 of the stem connection portion 222, to prevent the crown cap 210 from rotating relative to the crown stem 220, and ensure reliability of the crown 200.

In some examples, the first extension segment 430 disposed in an axial direction may be disposed only on the inner surface of the first side plate 212, or the second extension segment 440 disposed in an axial direction may be disposed only on the outer surface of the second side plate 2222. The first extension segment 430 or the second extension segment 440 is disposed, to improve, to some extent, connection stability between the first side plate 212 of the crown cap 210 and the second side plate 2222 of the stem connection portion 222.

In some embodiments, the inner surface of the first side plate 212 of the crown cap 210 may include the first thread structure 410 disposed in a circumferential direction and the first extension segment 430 disposed in an axial direction. An outer surface of the second side plate 2222 of the stem connection portion 222 may include the second thread structure 420 disposed in a circumferential direction and the second extension segment 440 disposed in an axial direction. It should be understood that the axial direction may be understood as a length direction of the crown stem 220 or a direction of a rotation axis of the crown 200, and the circumferential direction may be understood as a direction around the rotation axis.

For example, to further improve connection stability between the crown cap 210 and the crown stem 220, the crown stem 220 may be dipped in some green epoxy adhesive before rotating into the crown cap 210, and then the crown stem 220 is rotated into the crown cap 210. In other words, before assembling the crown cap 210 and the crown stem 220, adhesive dispensing may be performed at a circumferential thread position of the first thread structure 410 and/or the second thread structure 420, and then the crown cap 210 and the crown stem 220 are assembled, to ensure adhesive effect, prevent the crown cap 210 from rotating relative to the crown stem 220, and ensure reliability of the crown 200.

FIGS. 7A, 7B and FIGS. 8A, 8B and 8C are other example diagrams of structures of a crown according to an embodiment. FIG. 7A is a diagram of an overall structure of a crown, and FIG. 7B is an exploded view of the crown. FIG. 8A is a cross-sectional diagram of the crown, FIG. 8B is a diagram of a structure of a crown stem, and FIG. 8C is a diagram of structures of a crown cap and a plastic connector.

In a crown 200 shown in FIG. 7A to FIG. 8C, in addition to a crown cap 210 and a crown stem 220, the crown 200 may further include a plastic connector 230. In other words, the crown 200 includes the crown cap 210, the crown stem 220, and the plastic connector 230. For structures of the crown cap 210 and the crown stem 220, refer to the related descriptions in FIG. 2A to FIG. 3C. The plastic connector 230 is located between the crown cap 210 and the crown stem 220, and the plastic connector 230 is connected to the stem connection portion 222 of the crown stem 220.

It should be understood that the plastic connector 230 may be connected between the crown cap 210 and the stem connection portion 222 of the crown stem 220. The crown cap 210 may be fastened to the crown stem 220 through the plastic connector 230.

For example, the plastic connector 230 may be made of polyphenylene sulfide (PPS) and 20% glass fiber.

It should be noted that the plastic connector mainly plays a role of connecting the crown cap and the crown stem, that is, the plastic connector mainly plays a connection role, and the plastic connector is mainly made of a plastic material. Another type of material may be used. In this application, the plastic connector is mainly described as an example of a plastic material. However, in some other embodiments, the plastic connector may not be made of a plastic material.

In some embodiments, as shown in FIG. 7B, the plastic connector 230 includes a third top plate 231 and a third side plate 232. The third top plate 231 and the third side plate 232 are enclosed to form a connector groove 203. The connector groove 203 is located in the crown cap groove 201, and the crown stem groove 202 is located in the connector groove 203.

For example, the third top plate 231 includes an outer surface and an inner surface. The outer surface of the third top plate 231 is an outward-facing surface, namely, a surface close to the crown cap 210. The inner surface of the third top plate 231 is an inward-facing surface, namely, a surface close to the crown stem 220. Similarly, the third side plate 232 also includes two surfaces: an outer surface of the third side plate 232 and an inner surface of the third side plate 232, where the outer surface of the third side plate 232 is a surface close to the crown cap 210, and the inner surface of the third side plate 232 is a surface close to the crown stem 220.

That the third top plate 231 and the third side plate 232 are enclosed to form the connector groove 203 may be understood as that the inner surface of the third top plate 231 and the inner surface of the third side plate 232 may be enclosed to form the connector groove 203. The connector groove 203 may accommodate a part of the crown stem 220.

For example, a part or all of the stem connection portion 222 of the crown stem 220 may be located inside the connector groove 203, and a part or all of the plastic connector 230 may be located inside the crown cap groove 201. It can be understood that the outer surface of the second top plate 2221 is in contact with the inner surface of the third top plate 231, the outer surface of the second side plate 2222 is in contact with the inner surface of the third side plate 232, and the stem connection portion 222 may be embedded into the connector groove 203. The outer surface of the third top plate 231 is in contact with the inner surface of the first top plate 211, the outer surface of the third side plate 232 is in contact with the inner surface of the first side plate 212, and the plastic connector 230 may be embedded into the crown cap groove 201.

It should be understood that orientations of the crown stem groove 202, the crown cap groove 201, and the connector groove 203 are the same. For example, the crown stem groove 202, the crown cap groove 201, and the connector groove 203 are all disposed toward the watch movement.

In some embodiments, a third connection portion is disposed on an inner surface of the third side plate 232 of the plastic connector 230, a fourth connection portion is disposed on an outer surface of the second side plate 2222 of the stem connection portion 222, and the third connection portion is fastened to the fourth connection portion. It should be understood that, by disposing the third connection portion on the plastic connector 230 and disposing the fourth connection portion on the crown stem 220, the third connection portion and the fourth connection portion may be used together to implement fastening between the third connection portion and the fourth connection portion, thereby implementing fastening between the plastic connector 230 and the crown stem 220, and finally implementing fastening between the crown cap 210 and the crown stem 220.

For example, as shown in FIG. 8C, the third connection portion is a guide base 510, the fourth connection portion is a guide groove 520, and the guide base 510 is clamped with the guide groove 520.

It should be noted that positions of the guide base 510 and the guide groove 520 may be exchanged. For example, the third connection portion may be the guide groove 520, and the fourth connection portion may be the guide base 510.

It should be understood that, in this implementation, the guide base 510 and the guide groove 520 may be used in cooperation, that is, the guide base 510 is clamped into the guide groove 520, to implement fastening between the plastic connector 230 and the crown stem 220, and prevent relative movement between the plastic connector 230 and the crown stem 220.

In some embodiments, a fifth connection portion is disposed on an inner surface of the first side plate 212 of the crown cap 210, a sixth connection portion is disposed on an outer surface of the third side plate 232 of the plastic connector 230, and the fifth connection portion is fastened to the sixth connection portion. It should be understood that, by disposing the fifth connection portion on the crown cap 210 and disposing the sixth connection portion on the plastic connector 230, the fifth connection portion and the sixth connection portion may be used together to implement fastening between the fifth connection portion and the sixth connection portion, thereby implementing fastening between the crown cap 210 and the plastic connector 230, and finally implementing fastening between the crown cap 210 and the crown stem 220.

For example, the fifth connection portion may be of a boss structure, and the sixth connection portion may be of a concave structure, or the fifth connection portion may be of a concave structure, and the sixth connection portion may be of a boss structure. The boss structure and the concave structure are used together, so that the plastic connector 230 can be fastened to the crown cap 210. It should be understood that, in some embodiments, the crown cap 210 may be fastened to the plastic connector 230 by using a dispensing process, and the plastic connector 230 may be fastened to the crown stem 220 by using an adhesive dispensing process.

In some embodiments, the plastic connector 230 may be fastened to the crown cap 210 by using a nano molding process or an insert molding process, and the plastic connector 230 may be fastened to the stem connection portion 222 of the crown stem 220 by using an adhesive dispensing process. In the crown 200 shown in FIG. 7A to FIG. 8C, when the crown 200 is assembled, the plastic connector 230 and the crown cap 210 may be first assembled together by using a nano molding process, and then the plastic connector 230 is bonded to the stem connection portion 222 of the crown stem 220 by using an adhesive dispensing process.

The nano molding process is a nano molding technology (NMT), and is a process in which metal and plastic are combined by using nanotechnology. After a metal surface is nano-treated, plastic is directly injected and molded on the metal surface, so that the metal and the plastic can be integrated into one, and finally combined into one product. It should be understood that the "nano" herein refers to a microporous process, that is, nano-level microporous processing is performed on the metal surface by using a specific solution, and a main purpose is to better combine the metal surface with the plastic and improve connection strength.

The insert molding process is a process in which an insert is fastened at a proper position in an injection mold in advance, and then plastic is injected for molding. After the mold is opened, the insert is tightly wrapped and buried in the plastic after being cooled and solidified, to obtain a product with an insert like a thread or an electrode.

For example, the inner surface of the third top plate 231 of the plastic connector 230 may undergo adhesive dispensing processing, and/or the outer surface of the second top plate 2221 of the stem connection portion 222 may undergo adhesive dispensing processing (an adhesive dispensing position may be a position shown by a dashed line in FIG. 8A). This can increase bonding stability between the plastic connector 230 and the crown stem 220, and further ensure reliability of the crown 200.

It should be understood that, in this application, the guide base 510 and the guide groove 520 are disposed to prevent the crown stem 220 and the plastic connector 230 from rotating relative to each other. In addition, an adhesive is dispensed on the inner surface of the third top plate 231 of the plastic connector 230, and/or an adhesive is dispensed on the outer surface of the second top plate 2221 of the stem connection portion 222. When the plastic connector 230 and the crown stem 220 are assembled, the adhesive may overflow upward from the inner surface of the third top plate 231 to the guide base 510 and the guide groove 520. In this way, connection stability of the plastic connector 230 and the crown stem 220 may be further enhanced.

For example, the inner surface of the third top plate 231 of the plastic connector 230 may undergo laser engraving processing (namely, laser carving) and then undergo adhesive dispensing, and/or the outer surface of the second top plate 2221 of the stem connection portion 222 may undergo laser engraving processing (namely, laser carving) and then undergo adhesive dispensing. The laser engraving processing is performed to enhance a texture of the inner surface of the third top plate 231 of the plastic connector 230 and/or a texture of the outer surface of the second top plate 2221 of the stem connection portion 222, so as to further improve bonding stability of the plastic connector 230 and the crown stem 220, and further ensure reliability of the crown 200.

In some other embodiments, the stem connection portion 222 of the crown stem 220 may be fastened to the plastic connector 230 by using a nano molding process or an insert molding process, and the plastic connector 230 may be fastened to the crown cap 210 by using an adhesive dispensing process.

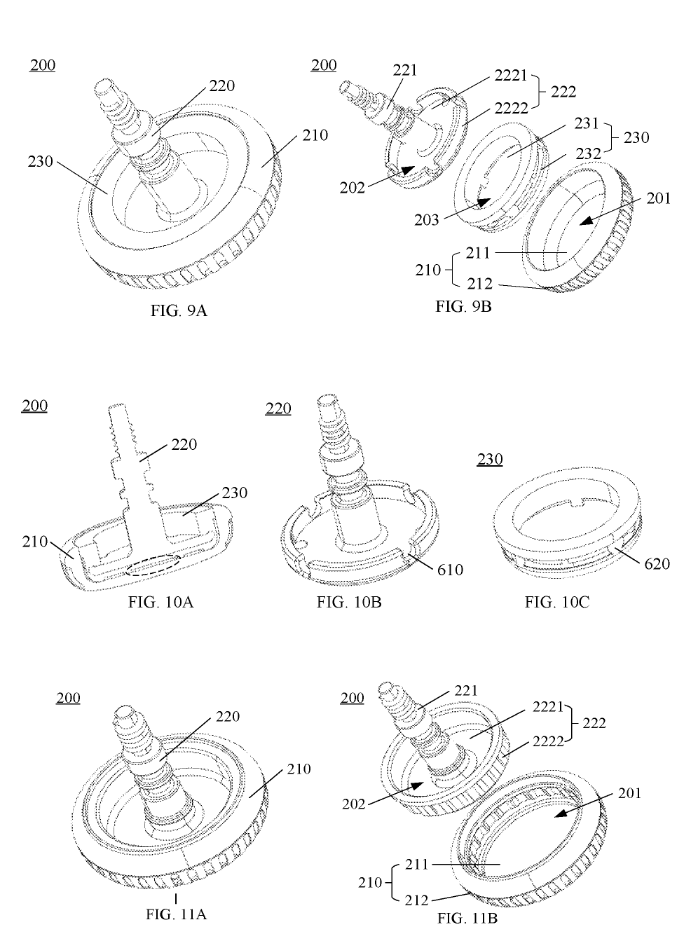

FIG. 9A to FIG. 10C are other example diagrams of structures of a crown according to an embodiment. FIG. 9A is a diagram of an overall structure of a crown, and FIG. 9B is an exploded view of the crown. FIG. 10A is a cross-sectional diagram of the crown, FIG. 10B is a diagram of a structure of a crown stem, and FIG. 10C is a diagram of a structure of a plastic connector.

For example, in the crown 200 shown in FIG. 9A to FIG. 10C, when the crown 200 is assembled, the plastic connector 230 and the stem connection portion 222 of the crown stem 220 may be first assembled together by using an insert molding process, and then the plastic connector 230 is bonded to the crown cap 210 by using an adhesive dispensing process.

For example, the outer surface of the third top plate 231 of the plastic connector 230 may undergo adhesive dispensing processing, and/or the inner surface of the first top plate 211 of the crown cap 210 may undergo adhesive dispensing processing (an adhesive dispensing position may be a position shown by a dashed line in FIG. 10A). This can increase bonding stability between the plastic connector 230 and the crown cap 210, and further ensure reliability of the crown 200.

For example, the outer surface of the third top plate 231 of the plastic connector 230 may undergo laser engraving processing (namely, laser carving) and then undergo adhesive dispensing, and/or the inner surface of the first top plate 211 of the crown cap 210 may undergo laser engraving processing (namely, laser carving) and then undergo adhesive dispensing. The laser engraving processing is performed to enhance a texture of the outer surface of the third top plate 231 of the plastic connector 230 and/or a texture of the inner surface of the first top plate 211 of the crown cap 210, so as to further improve bonding stability of the plastic connector 230 and the crown cap 210, and further ensure reliability of the crown 200.

In some embodiments, as shown in FIG. 10B and 10C, a notch 610 may be disposed on the second side plate 2222 of the stem connection portion 222 of the crown stem 220, and a filling portion 620 corresponding to the notch 610 may be disposed on the third side plate 232 of the plastic connector 230, so that the crown stem 220 may be connected to the plastic connector 230 by using an inject molding process, thereby implementing fastening between the crown stem 220 and the plastic connector 230. Further, fastening between the plastic connector 230 and the crown cap 210 may be implemented by using an adhesive dispensing process.

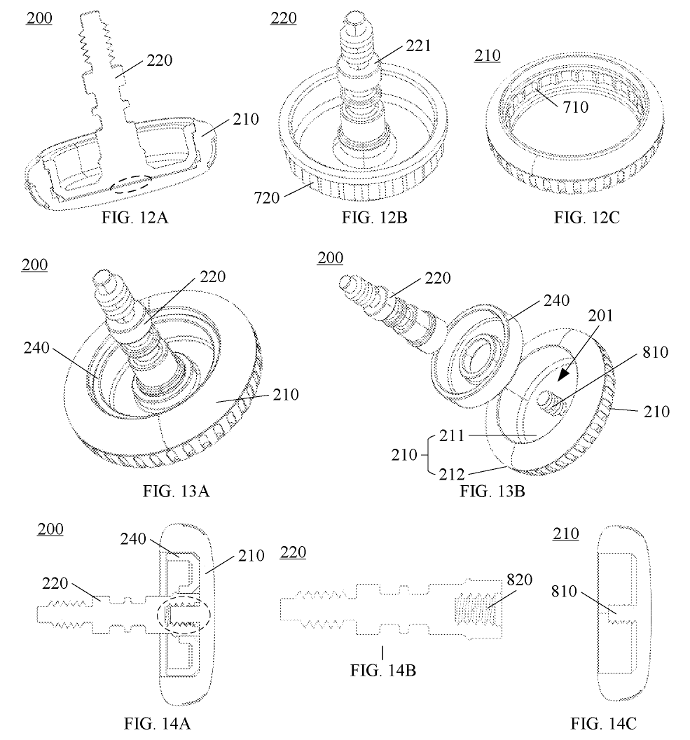

FIG. 11A to FIG. 12C are other example diagrams of structures of a crown according to an embodiment. FIG. 11A is a diagram of an overall structure of a crown, and FIG. 11B is an exploded view of the crown. FIG. 12A is a cross-sectional diagram of the crown, FIG. 12B is a diagram of a structure of a crown stem, and FIG. 12C is a diagram of a structure of a crown cap.

In some embodiments, as shown in FIG. 11A to FIG. 12C, the stem connection portion 222 of the crown stem 220 may be fastened inside the crown cap 210 in an interference fit manner. That is, the stem connection portion 222 of the crown stem 220 may be fastened inside the crown cap groove 201 in an interference fit manner.

For example, to generate an interference fit, the stem connection portion 222 may be cooled to reduce a size of the stem connection portion 222 in at least one direction. The cooled stem connection portion 222 is introduced into the crown cap groove 201 and returned to a room temperature, so that the stem connection portion 222 expands to a slightly larger size, thereby forcing the outer surface of the second side plate 2222 of the stem connection portion 222 to press against the inner surface of the first side plate 212 of the crown cap 210. For another example, the crown cap 210 may be heated to expand a size of the crown cap groove 201, so that the stem connection portion 222 is introduced into the crown cap groove 201. Once the crown cap 210 is cooled, the crown cap groove 201 shrinks to a smaller size, thereby forcing the inner surface of the first side plate 212 of the crown cap 210 to push against the outer surface of the second side plate 2222 of the stem connection portion 222.

In some embodiments, the inner surface of the first top plate 211 of the crown cap 210 may undergo adhesive dispensing processing, and/or the outer surface of the second top plate 2221 of the stem connection portion 222 may undergo adhesive dispensing processing (an adhesive dispensing position may be a position shown by a dashed line in FIG. 12A). This can increase bonding stability the crown cap 210 and the crown stem 220, and can ensure reliability of the crown 200.

In some embodiments, the inner surface of the first top plate 211 of the crown cap 210 may undergo laser engraving processing (namely, laser carving) and then undergo adhesive dispensing, and/or the outer surface of the second top plate 2221 of the stem connection portion 222 may undergo laser engraving processing (namely, laser carving) and then undergo adhesive dispensing. The laser engraving processing is performed to enhance a texture of the inner surface of the first top plate 211 of the crown cap 210 and/or a texture of the outer surface of the second top plate 2221 of the stem connection portion 222, so as to further increase bonding stability between the crown cap 210 and the crown stem 220, and further ensure reliability of the crown 200.

In some embodiments, as shown in FIG. 12C, a protrusion 710 is disposed on the inner surface of the first side plate 212 of the crown cap 210, a recess 720 is disposed on the outer surface of a second side plate 2222 of the stem connection portion 222, and the protrusion 710 is clamped in the recess 720.

It should be understood that there may be a plurality of protrusions 710 and a plurality of recesses 720. The plurality of protrusions 710 may be disposed along the inner surface of the first side plate 212, and the plurality of recesses 720 may be disposed along the outer surface of the second side plate 2222. The plurality of protrusions 710 and the plurality of recesses 720 are cooperated with each other one by one, and are clamped together, to avoid relative rotation between the crown cap 210 and the crown stem 220.

It should be noted that positions of the protrusion 710 and the recess 720 may be exchanged. For example, the recess 720 is disposed on the inner surface of the first side plate 212 of the crown cap 210, and the protrusion 710 is disposed on the outer surface of the second side plate 2222 of the stem connection portion 222.

It should be understood that, in the implementation, fastening between the crown cap 210 and the crown stem 220 is implemented by clamping the protrusion 710 into the recess 720, to prevent rotation between the crown cap 210 and the crown stem 220.

In some embodiments, in the crown 200 shown in FIG. 2A to FIG. 12C, the crown 200 may further include a plastic mechanical part. The plastic mechanical part is fastened in the crown stem groove 202 and sleeved on a periphery of the crown stem 220. The plastic mechanical part can reduce a damping feel of a user when the crown is rotated, thereby improving user experience. For example, the plastic mechanical part may be made of polyformaldehyde (POM) or polyether ether ketone (PEEK).

In some embodiments, in the crown 200 shown in FIG. 2A to FIG. 12C, the crown 200 may further include a crown tube, and a part of the crown tube may be located in the crown stem groove 202 and sleeved around the crown stem 220. For example, the crown tube may be made of a material similar to that of the crown stem 220, for example, may be made of stainless steel.

FIGS. 13A, 13B and FIGS. 14A-14C are other example diagrams of structures of a crown according to an embodiment. FIG. 13A is a diagram of an overall structure of a crown, and FIG. 13B is an exploded view of the crown. FIG. 14A is a cross-sectional diagram of the crown, FIG. 14B is a diagram of a structure of a crown stem, and FIG. 14C is a diagram of a structure of a crown cap.

As shown in FIG. 13A to FIG. 14C, the crown 200 may include the crown cap 210, the crown stem 220, and the plastic mechanical part 240. The crown cap 210 includes a first top plate 211 and a first side plate 212. The first side plate 212 and the first top plate 211 are enclosed to form a crown cap groove 201. A screw rod 810 is disposed on an inner surface of the first top plate 211 of the crown cap 210, and a threaded hole 820 corresponding to the screw rod 810 is disposed on a first end of the crown stem 220.

The plastic mechanical part 240 is fastened in the crown cap groove 201 of the crown cap 210 and sleeved on a periphery of the crown stem 220. The plastic mechanical part 240 can reduce a damping feel of a user when the crown is rotated, thereby improving user experience. For example, the plastic mechanical part 240 may be made of POM or PEEK.

The crown stem 220 may pass through the plastic mechanical part 240, and is connected to the screw rod 810 of the crown cap 210 through the threaded hole 820 (as shown in a dashed area in FIG. 14A, to implement fastening between the crown cap 210 and the crown stem 220.

In some embodiments, the inner surface of the first top plate 211 of the crown cap 210 may be sealed through adhesive dispensing (sealed at a position in which the crown cap 210 and the crown stem 220 are combined), to prevent an electrochemical corrosion problem caused by long-time accumulation of sweat, and ensure reliability of the crown 200.

In some embodiments, the crown 200 may further include a crown tube, and a part of the crown tube may be located in the plastic mechanical part 240 and sleeved around the crown stem 220. For example, the crown tube may be made of a material similar to that of the crown stem 220, for example, may be made of stainless steel.

It should be understood that the crown cap 210 and the crown stem 220 are two independent components. The crown cap 210 and the crown stem 220 are separately and independently disposed, so that the crown cap 210 and the crown stem 220 may be made of different materials. For example, the crown cap 210 may be made of a material that can be anodized or a material that is easy to color, and the crown stem 220 may be made of a material with selected mechanical strength. In this way, the crown 200 can present any color, and mechanical reliability of the crown 200 is ensured, thereby balancing aesthetics and mechanical performance.

For example, insulation PVD processing may be performed at a contact position between the crown stem 220 and the crown cap 210, to prevent electrochemical corrosion between the crown cap 210 and the crown stem 220 during long-term wearing.

In some other embodiments, a screw rod 810 may be disposed on the inner surface of the first top plate 211 of the crown cap 210, and a screw hole 910 corresponding to the screw rod 810 may be disposed on the first end of the crown stem 220, or the screw hole 910 may be disposed on the inner surface of the first top plate 211 of the crown cap 210, and the screw rod 810 corresponding to the screw hole 910 may be disposed on the first end of the crown stem 220.

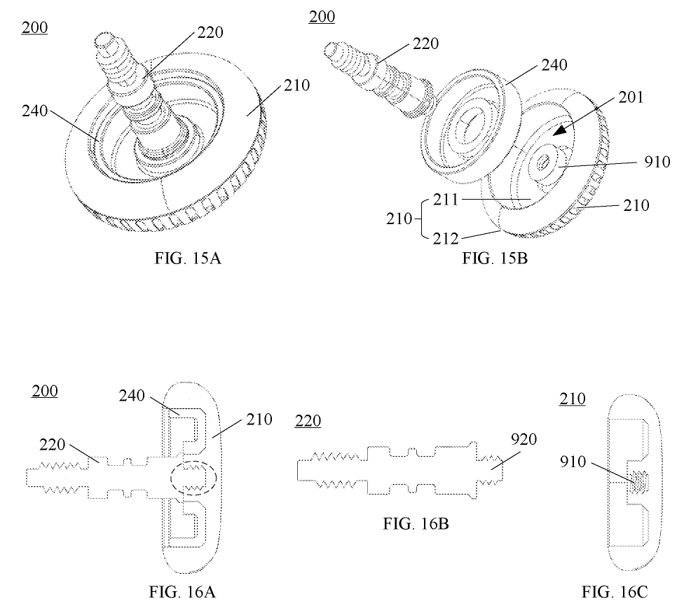

FIG. 15A to FIG. 16C are other example diagrams of structures of a crown according to an embodiment. FIG. 15A is a diagram of an overall structure of a crown, and FIG. 15B is an exploded view of the crown. FIG. 16A is a cross-sectional diagram of the crown, FIG. 16B is a diagram of a structure of a crown stem, and FIG. 16C is a diagram of a structure of a crown cap.

In the crown 200 shown in FIG. 15A to FIG. 16C, a screw hole 910 is disposed on an inner surface of the first top plate 211 of the crown cap 210, and a screw rod 920 corresponding to the screw hole 910 is disposed on a first end of the crown stem 220. The crown stem 220 may pass through the plastic mechanical part 240, and is connected to the screw hole 910 of the crown cap 210 through the screw rod 920 (as shown in a dashed area in FIG. 16A, to implement fastening between the crown cap 210 and the crown stem 220.

The foregoing describes in detail a crown assembly provided in embodiments with reference to FIG. 2A to FIG. 16C.

It should be understood that, in some embodiments, a combination manner between the crown cap 210 and the crown stem 220 may be a combination of two components. As shown in FIG. 2B, FIG. 5, FIG. 11B, FIG. 13B, and FIG. 15B, a corresponding connection structure may be disposed on the crown cap 210 and the crown stem 220 to directly connect the crown cap 210 and the crown stem 220 without using another connector (for example, the plastic connector 230).

In some other embodiments, a combination manner between the crown cap 210 and the crown stem 220 may be a combination of three components, that is, a connector (for example, the plastic connector 230) may be disposed between the crown cap 210 and the crown stem 220 to implement fastening. As shown in FIGS. 7A, 7B, and FIGS. 9A and 9B, the crown cap 210 may be fastened to the crown stem 220 through the plastic connector 230.

In some other embodiments, a combination manner between the crown cap 210 and the crown stem 220 may be a combination of four or more components, that is, a plurality of (two or more) connectors may be disposed between the crown cap 210 and the crown stem 220, to implement fastening between the crown cap 210 and the crown stem 220.

It should be noted that, no matter how many connectors are disposed between the crown cap 210 and the crown stem 220, for a structure of the connector, reference may be made to a structure of the plastic connector 230, that is, a corresponding clamping structure (for example, a groove or a protrusion structure) may be disposed on an inner/outer surface of the connector, to implement fastening between the connector and another component.

For example, a first connector and a second connector may be disposed between the crown cap 210 and the crown stem 220, and the first connector may be the foregoing plastic connector 230. The first connector may include a first connector groove (namely, the connector groove 203), and the second connector may include a second connector groove. In addition, the first connector groove and the second connector groove face the same direction as the crown stem groove 202 or the crown cap groove 201. Therefore, a groove-in-groove structure similar to that in FIG. 7B can be formed. In other words, the first connector may be located between the crown cap 210 and the second connector, and the second connector may be located between the first connector and the crown stem 220. The first connector groove may be located in the crown cap groove 201, the second connector groove may be located in the first connector groove, and the crown stem groove 202 may be located in the second connector groove. In addition, a corresponding clamping structure may be disposed on an inner surface and/or an outer surface of the first connector and/or the second connector, so that the first connector is clamped in the crown cap 210, the second connector is clamped in the first connector, and the crown stem 220 is clamped in the second connector. The crown cap 210 is fastened to the crown stem 220 in a nested and clamped manner.

The foregoing descriptions are merely examples of implementations, but are not intended to limit the protection scope of this disclosure. Any variation or replacement readily figured out by a person skilled in the art within the technical scope disclosed shall fall within the protection scope of this disclosure. Therefore, the protection scope of this disclosure shall be subject to the protection scope of the claims.

What is claimed is:

1. A wearable device comprising:
a crown assembly comprising:
a crown cap comprising a first top plate and a first side plate that together form a crown cap groove, wherein the first top plate comprises a first outer surface;
a crown stem at least partially disposed in the crown cap groove and comprising:
a stem body comprising a first end and a second end; and
a stem connection portion, comprising:
a second top plate connected to the first end; and
a second side plate forming a crown stem groove with the second top plate; and
a plastic connector disposed between the crown cap and the crown stem, wherein the plastic connector comprises a third top plate and a third side plate that together form a connector groove disposed in the crown cap groove and disposing the crown stem groove,
wherein the crown cap groove, the connector groove, and the crown stem groove each open in an axial direction of the stem body substantially perpendicular to the first outer surface.

2. The wearable device of claim 1, wherein the crown cap comprises aluminum, magnesium, titanium, zinc, or nickel, and wherein the crown stem comprises stainless steel or titanium alloy.

3. The wearable device of claim 1, wherein the crown cap further comprises a first connection portion disposed on an inner surface of the first side plate , wherein the stem connection portion further comprises a second connection portion disposed on a second outer surface of the second side plate, and wherein the first connection portion is fastened to the second connection portion.

4. The wearable device of claim 3, wherein the first connection portion is a rotation groove, wherein the second connection portion is a boss that fits the rotation groove, and wherein the boss is configured to rotate into the rotation groove.

5. The wearable device of claim 4, further comprising:
a first groove disposed on the inner surface;
a second groove disposed on the second outer surface; and either
a first projection of the first groove on the second side plate at least partially overlapping the second groove, or a second projection of the second groove on the first side plate at least partially overlapping the first groove.

6. The wearable device of claim 3, wherein the first connection portion is a first threaded structure disposed in a circumferential direction, wherein the second connection portion is a second threaded structure disposed in the circumferential direction, and wherein the crown cap is configured to rotate through the first threaded structure into the second threaded structure so that the crown cap fastens to the crown stem.

7. The wearable device of claim 6, wherein the first threaded structure comprises a first extension segment extending in the axial direction on the inner surface, and wherein the second threaded structure comprises a second extension segment extending in the axial direction on the second outer surface.

8. The wearable device of claim 1, wherein the plastic connector comprises polyphenylene sulfide (PPS).

9. The wearable device of claim 1, wherein the second side plate comprises a notch, and wherein the plastic connector further comprises a filling portion disposed on the third side plate and corresponding to the notch.

10. The wearable device of claim 1, wherein the plastic connector is fastened to the crown cap by a nano mold or an insert mold, and wherein the plastic connector is fastened to the stem connection portion of the crown stem by an adhesive.

11. The wearable device of claim 1, wherein the stem connection portion is fastened to the plastic connector by a nano mold or an insert mold, and wherein the plastic connector is fastened to the crown cap by an adhesive.

12. The wearable device of claim 1, wherein the plastic connector further comprises a third connection portion disposed on an inner surface of the third side plate , wherein the stem connection portion further comprises a fourth connection portion disposed on a second outer surface of the second side plate, and wherein the third connection portion is fastened to the fourth connection portion.

13. The wearable device of claim 12, wherein the third connection portion is a guide base, wherein the fourth connection portion is a guide groove, and wherein the guide base is clamped into the guide groove.

14. The wearable device of claim 1, wherein the crown cap further comprises a fifth connection portion disposed on an inner surface of the first side plate, wherein the plastic connector further comprises a sixth connection portion disposed on a second outer surface of the third side plate , and wherein the fifth connection portion is fastened to the sixth connection portion.

15. The wearable device of claim 1, wherein the stem connection portion is fastened inside the crown cap groove in an interference fit manner.

16. The wearable device of claim 15, wherein the crown cap further comprises a protrusion disposed on an inner surface of the first side plate , wherein the stem connection portion further comprises a recess disposed on a second outer surface of the second side plate, and wherein the protrusion is clamped in the recess.

17. A crown assembly, comprising:
a crown cap comprising a first top plate and a first side plate that together form a crown cap groove, wherein the first top plate comprises a first outer surface;
a crown stem at least partially disposed in the crown cap groove and comprising:
a stem body comprising a first end and a second end; and
a stem connection portion, comprising:
a second top plate connected to the first end; and
a second side plate forming a crown stem groove with the second top plate; and
a plastic connector disposed between the crown cap and the crown stem, wherein the plastic connector comprises a third top plate and a third side plate that together form a connector groove disposed in the crown cap groove and disposing the crown stem groove,
wherein the crown cap groove, the connector groove, and the crown stem groove each open in an axial direction of the stem body substantially perpendicular to the first outer surface.

18. The crown assembly of claim 17, wherein the crown cap further comprises aluminum, magnesium, titanium, zinc, or nickel, and wherein the crown stem comprises stainless steel or titanium alloy.

19. The crown assembly of claim 17, wherein the crown cap further comprises a first connection portion disposed on an inner surface of the first side plate of the crown cap, a second connection portion disposed on an outer surface of the second side plate of the stem connection portion, and wherein the first connection portion is fastened to the second connection portion.

20. The crown assembly of claim 19, wherein the first connection portion is a rotation groove, wherein the second connection portion is a boss that fits the rotation groove, and wherein the boss is configured to rotate into the rotation groove.
